(19) United States
(12) Patent Application Publication
(10) Pub. No.: US 2009/0318328 A1
(43) Pub. Date: Dec. 24, 2009

(54) Liquid Softener Composition

(75) Inventors: Manlio Gallotti, Sao Paulo (BR); George Italo Pitombeira Nunes, Sao Paulo (BR); Patricia Ramos P. De Moraes, Sao Paulo (BR); Natanael De Almeida, Sao Paulo (BR); Claudia Barge, Sao Paulo (BR); Gustavo Kume, Sao Paulo (BR); Denise Aparecida Acacio Paulino, Sao Paulo (BR)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT (BRAZIL) S.A., Sao Paulo-SP (BR)

(21) Appl. No.: 12/307,527

(22) PCT Filed: Jul. 3, 2007
(86) PCT No.: PCT/EP07/05860

§ 371 Date: Feb. 24, 2009

(30) Foreign Application Priority Data
Jul. 6, 2006 (EP) 06013998.7

(51) Int. Cl. C11D 3/26

(52) U.S. Cl. 510/527

(57) ABSTRACT

A stable, homogenous and viscous softener formulation is claimed which contains less than 50% by weight of an esterquat compound of the formula

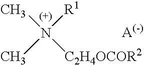

wherein R¹ is —C₂H₄OH or —C₂H₄OCOR², R² is C₁₁-C₂₁-alkyl or alkenyl and A is an anion, as methylsulfate, bromide, iodide and, preferably, chloride, said esterquat being prepared by esterification of methyldiethanolamine with fatty acids and subsequent quaternization, with preferably methylchloride, the fatty acids containing at least 50% by weight of saturated C₁₈-fatty acid, comprising a final product containing at least 50 mol % of diester quat and at least 10 mol % of monoesterquat and having an acid value of less than 0.12 meq/g of esterquat active material, the rest being water and an organic solvent.

This invention relates to a liquid softener composition containing a dimethyldiethanolamine esterquat.

Esterquats are commonly known in the market for presenting problems concerning the production of viscous softeners, obliging the use of thickeners to achieve a high viscosity in the final product. High viscosities are especially important for some countries, more frequently in Latin America and Asia, where consumers still relate the good quality of a product to its viscosity.

In the present invention, it is shown that it is possible to significantly increase the viscosity of fabric softeners based on esterquats by lowering the temperature of the process, which allows an expressive reduction or even the complete removal of thickeners from the final formulation. It is basically disclosed a new option for working with esterquats in the production of fabric softeners, consisting of a highly concentrated esterquat composition dispersible in water at temperatures below 60° C.

Many patents have claimed the use of dimethyldiethanolamine esterquats for fabric softener formulations. Patent WO 01/42412 claims the use of a softening compound having a transition temperature of less than 30° C. for providing good in-wear comfort. Unsaturated dimethyldiethanolamine esterquats present a transition temperature below 30° C., but when saturated, which are the preferred composition of the present patent, they present a transition temperature above that. In patent WO 01/34743, dimethyldiethanolamine esterquats are cited among the preferred quaternary ammonium compounds. However, it is also claimed the obligatory use of metal chelating agents. The patent WO 99/27046 cites dimethyldiethanolamine esterquat as a possible cationic compound for rinse-added fabric softening compositions, including translucent or clear liquid compositions, but it is obligatory to associate it with a polyoxyalkylene alkyl amide surface active agent. A concentrated esterquat composition with water and solvent is disclosed in the patent application JP 10 251 972. However, in this patent is also claimed the obligatory use of alkali and alkaline earth metal salts which are included in the present invention as optional ingredients.

It has now been found that are some parameters that are important to optimize the final softener formulation viscosity. As it can be seen in the example, the acid value of the raw material must be less than 0.12 meq/g of esterquat active material, otherwise the viscosity of the final softener formulation will be significantly lower.

The invention provides liquid esterquat compositions containing less than 50% by weight of an esterquat compound of the formula

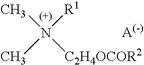

wherein R¹ is —C₂H₄OH or —C₂H₄OCOR², R² is C₁₁-C₂₁-alkyl or alkenyl and A is an anion, as methylsulfate, bromide, iodide and, preferably, chloride, said esterquat being prepared by esterification of methyldiethanolamine with fatty acids and subsequent quaternization, with preferably methylchloride, the fatty acids containing at least 50% by weight of saturated C₁₈-fatty acid, the esterquat containing at least 50 mol % of diester quat and at least 10 mol % of monoesterquat and having an acid value of less than 0.12 meq/g of esterquat active material, the rest being water and an organic solvent.

The group —COR² is preferably derived from natural occurring fatty acids such as capronic acid, caprylic acid, caprinic acid, lauric acid, myristiric acid, palmic acid, isostearic acid, stearic, oleic acid, eluidinic acid, arachinic acid, behenic acid and eruca acid. Preferred acids containing the group —COR² are C₁₂/C₁₈ coco fatty acids, tallow fatty acid, fully or partially hydrogenated tallow fatty acid, palm fatty acid, partially or fully hydrogenated palm fatty acid or stearic acid.

These esterquats are made by methods known per se, for example by esterification of methyl-diethanolamine with a fatty acid of the formula R²COOH and subsequent quaternization with preferably methylchloride or dimethylsulfate or any other quaternization agent introducing a methyl group. The fatty acids used must be of such kind that they contain at least 50% by weight of saturated C₁₈-fatty acid. Preferably the fatty acid is derived from vegetable and/or animal fatty acid and contains at least 50% by weight of saturated fatty C₁₈-acid, more preferably from 52 to 90% by weight of saturated C₁₈-fatty acid and even more preferably from 55 to 85% by weight of saturated fatty acid. The molar relationship in the esterification between methyldiethanolamine and fatty acid must be such that the relationship of at least 50 mol-% diester quat and at least 10 mol-% monoesterquat is maintained.

In order to decrease the process temperature and consequently increase the viscosity of the final softener formulation, a concentrated pre-mixture of the dimethyldiethanolamine esterquat with water and solvent can be made. The pre-mixture of the dimethyldiethanolamine esterquat molten temperature should be from about 25 to 65° C., most preferably from about 30 to 60° C. Also, the difference in temperature between the molten esterquat pre-mixture and the liquid carrier, preferably water, should be up to 15° C., more preferably up to 12° C., even more preferably up to 10° C.

Due to the presence of organic solvents in the esterification process and also in the pre-mixture of the dimethyldiethanolamine esterquat, the liquid softener composition as claimed herein contain a small amount of such solvents.

In principle, suitable organic solvents in the final esterquat are any mono- or polyhydric alcohols. Preference is given to using alcohols having from 1 to 4 carbon atoms, such as methanol, ethanol, propanol, isopropanol, straight chain and branched butanol, glycerol and mixtures of said alcohols. Other preferred solvents are polyethylene glycols having a relative molecular mass below 2000. The claimed composition may contain these organic solvents in an amount of from 0.13 to 18% by weight of the whole composition.

Depending on the intended use, the compositions according to the invention comprise, in addition to the mentioned compounds, additives and auxiliaries which are customary and specific in each case such as for example stabilizers, perfumes, colorants, hydrotopes, antifoaming agents, polymeric or other thickening agents, opacifiers, preservatives, anti-corrosion agents and pH modifiers.

In order to make easier the preparation of the disclosed invention, a concentrated pre-mix containing the same molar and/or mass ratio between the esterquats and the additives can be prepared in order to be diluted up to 45 times. Other ingredients, such as solvent, water and any other ingredient that could be part of the final formulation may be added.

Stabilizers and/or other additives can be selected from the group of specific organic and/or inorganic compound, preferably electrolytes and/or short amines derivates. A problem of aqueous composition containing these esterquats is that they are not stable over prolonged storage since they undergo hydrolysis. It has been found that, apart from alkali and alkaline earth metal salts, there are also other metal salts capable of preventing hydrolysis of esterquats.

In order to enhance the stability of the aqueous esterquat compositions, a salt may be added such as alkali or alkaline earth metal salt. Preferred salts, however, are transition metal salts, more preferably zinc and aluminium salts such as ZnSO₄, ZnCl₂, AlCl₃ or Al₂(SO₄)₃. These salts may be present in an amount preferably from 0.002 to 10.0, preferably 0.03 to 5.0, and even more preferably 0.04 to 3.0% by weight.

The compositions according to the present invention can be made by mixing the cited salts to the dimethyldiethanolamine esterquat disclosed in this invention in the final softener formulations. The salt can be added at any moment during the softeners process preparation and either in solid form or an aqueous solution. Heating and stirring is recommended for making the claimed compositions.

The compositions according to the invention may have the presence of rare earth metal salts, metal salts of fatty acids, phthalocyanine metal complexes, phthalocyanine metal salts or chelating agents.

Another option for stabilizers is short amines, which can be selected from the group of amines containing at least one hydroxyethyl group.

Preferred thickeners which may be added if necessary, are fatty alcohols, hydrogenated castor oil, salts of long-chain fatty acids, which are preferably used in amounts of from 0 to 15% by weight and in particular in amounts from 0.2 to 14% by weight, in particular it can be xanthan gum, guar guar, agar agar, alginates and tyloses, Carboxymethylcellulose and Hydroxyethylcellulose, and also relatively high molecular weight polyethylene glycol mono- and -diesters of fatty acids, polyacrylates, polyvinyl alcohol and Polyvinylpyrrolidone, and also electrolytes. It can also be selected from the group of synthetic and/or natural organic polymers such as modified polyglucopyranoses and/or modified celluloses.

The compositions according to the present invention can be made by heating the water to the necessary temperature and then adding the melting esterquat pre-mixture, stirring until obtain a homogeneous fabric softener.

An example of the procedure to obtain a stable, homogeneous and viscous fabric softener formulation based on methyldiethanolamine esterquat as described on claim 1 of the present invention is:
I. Heating of water to 45° C.
II. Addition of the dimethyldiethanolamine esterquat pre-dispersion at 50° C.
III. Cooling under stirring with approximately 150 rpm for 30 minutes
IV. Fast cooling under stirring for 15 minutes

The fabric softener formulation prepared according to the procedure and to the dimethyldiethanolamine esterquat disclosed in this invention exhibits good viscosities results, especially for low active-material levels as shown on tables I and II. Moreover, table I proves the important effect that the acid value content has on the fabric softener formulation viscosity. The acid value, in addition with saturated C18 content and ester distribution are important parameters disclosed in this invention. On table II a comparative with other well-known softener active agents such as DSDMAC and triethanolamine esterquats is shown. For the latter, it was used a pre-dispersion of triethanolamine esterquat as described on Patent EP-1 584 674. This pre-dispersion, as the one prepared for the dimethyldiethanolammonium-chloride esterquat disclosed in this patent, is used to decrease process temperature in order to increase viscosity results.

The results shows that with the dimethyldiethanolamine esterquat disclosed in this invention a viscous softener formulation is obtained, even for fabric softeners containing 2% am, and the fabric softeners viscosity results are clearly better than fabric softeners prepared through the other two cited softener active agents. It is important to notice that for a softener formulation based on a commercial available triethanolamine esterquat achieve the same viscosity levels of the fabric softener formulation based on the dimethyldiethanolamine esterquat disclosed in this patent, a large amount of thickener would be necessary. This is, in fact, a characteristic of the commercial available triethanolamine esterquats that is the low fabric softeners viscosity values when working with low active material content, even using its pre-dispersion.

TABLE I

| | dimethyldi- | dimethyldi- | dimethyldi- |
|---|---|---|---|
| | ethanolamine | ethanolamine | ethanolamine |
| | Esterquat 1 | Esterquat 2 | Esterquat 3 |
| Saturated C18 Content (%) | >50% | >50% | >50% |
| Acid Value (meq/g of final | 0.132 | 0.031 | 0.031 |
| product) | | | |
| Diester Content (mol %) | >50% | >50% | >50% |
| Monoester Content (mol %) | >10% | >10% | >10% |
| Fabric Softener with 2% am | 20 | 1275 | 1730 |
| Viscosity (mPas) | | | |
| Fabric Softener with 4% am | 550 | 2790 | 2735 |
| Viscosity (mPas) | | | |

TABLE II

| | dimethyldi- | di-stearyl-dimethyl- | Triethanol- |
|---|---|---|---|
| | ethanolamine | ammonium-chloride | amine |
| | Esterquat 2 | DSDMAC | esterquat |
| Fabric Softener with | 1275 | 35 | 20 |
| 2% am Viscosity | | | |
| (mPas) | | | |
| Fabric Softener with | 2790 | 2165 | 210 |
| 4% am Viscosity | | | |
| (mPas) | | | |

1. A stable, homogenous and viscous softener formulation containing less than 50% by weight of an esterquat compound of the formula 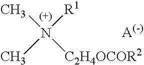
wherein
R¹ is —C₂H₄OH or —C₂H₄OCOR²,
R² is C₁₁-C₂₁-alkyl or alkenyl and
A is an anion, selected from the group consisting of:
methylsulfate, bromide, iodide and, chloride, wherein the esterquat is prepared by a process comprising the steps of esterifying methyldiethanolamine with a fatty acid mixture wherein the fatty acids mixture contains at least 50% by weight of saturated C₁₈-fatty acid, to form an esterified methyl-diethanolamine and subsequently quaternizing the esterified methyldiethanolamine, wherein the final esterquat product contains at least 50 mol % of diester quat and at least 10 mol % of monoesterquat and has an acid value of less than 0.12 meq/g of esterquat active material, the rest being water and an organic solvent.

2. A composition as claimed in claim 1, wherein the fatty acid mixture contains 52 to 90% by weight of saturated C₁₈-fatty acid.

3. A composition as claimed in claim 1, wherein the fatty acid mixture contains 55 to 85% by weight of saturated C₁₈-fatty acid.

4. A composition as claimed in claim 1, wherein the fatty acid mixture is fully hydrogenated.

5. A process of making a liquid fabric softener composition as described in claim 1, comprising the step of preparing a molten pre-mixture of the dimethyldiethanolamine esterquat in order to decrease process temperature and obtain stable, homogeneous and viscous softener formulation.

6. The process of claim 5 wherein the pre-mixture molten temperature is from about 25 to 65° C.

7. The process according to claim 5 wherein the temperature difference between the molten pre-mixture and the liquid carrier, is up to 15° C.

8. A liquid, stable and viscous softener formulation as described in claim 1, containing the dimethyldiethanolamine esterquat in a level from about 1 to 20% and optionally additional ingredients in order to enhance stability, viscosity and dispersibility, such as stabilizers, electrolytes, thickeners, dispersing agents and pH modifiers.

9. A liquid, stable and viscous softener formulation composition according to claim 8 wherein the stabilizers can be selected from the group of inorganic and/or organic compounds such as soluble transition metals salts and short amines derivatives.

10. A liquid, stable and viscous softener formulation composition according to claim 8 wherein the thickener is selected from the group consisting of synthetic and/or natural organic polymers such as modified polyglucopyranoses and/or modified celluloses.

11. A liquid, stable and viscous softener formulation composition according to claim 8 wherein the pH modifiers are any organic or inorganic acids.

12. A stable, homogenous and viscous softener formulation containing less than 50% by weight of an esterquat compound of the formula 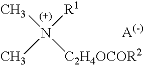
wherein
R¹ is —C₂H₄OH or —C₂H₄OCOR²,
R² is C₁₁-C₂₁-alkyl or alkenyl and
A is an anion, selected from the group consisting of: methylsulfate, bromide, iodide and, chloride,
wherein the esterquat is prepared by a process comprising the steps of esterifying methyldiethanolamine with at least one fatty acid to form an esterified methyl-diethanolamine and subsequently quaternizing the esterified methyldiethanolamine, wherein the final esterquat product contains at least 50 mol % of diester quat and at least 10 mol % of monoesterquat and has an acid value of less than 0.12 meq/g of esterquat active material, the rest being water and an organic solvent.

13. A composition as claimed in claim 12, wherein the at least one fatty acid contains 52 to 90% by weight of saturated C₁₈-fatty acid.

14. A composition as claimed in claim 12, wherein the at least one fatty acid contains 55 to 85% by weight of saturated C₁₈-fatty acid.

15. A composition as claimed in claim 12, wherein the at least one fatty acid is fully hydrogenated.

16. A process of making a liquid fabric softener composition as described in claim 12, comprising the step of preparing a molten pre-mixture of the dimethyldiethanolamine esterquat in order to decrease process temperature and obtain stable, homogeneous and viscous softener formulation.
